(19) United States
(12) Patent Application Publication
(10) Pub. No.: US 2012/0153881 A1
(43) Pub. Date: Jun. 21, 2012

(54) VECTOR CONTROL METHOD FOR ELECTRIC MOTORS

(75) Inventors: Riccardo Parenti, Pieve Ligure (IT); Vincenzo D'Ambrosio, Barletta (IT)

(73) Assignee: ANSALDO ENERGIA S.P.A., Genova (IT)

(21) Appl. No.: 13/265,710

(22) PCT Filed: Apr. 21, 2010
(86) PCT No.: PCT/IB2010/000888

§ 371 Date: Mar. 2, 2012

(30) Foreign Application Priority Data
Apr. 22, 2009 (IT) TO2009A000316

(51) Int. Cl. H02P 21/00

(52) U.S. Cl. 318/400.02

(57) ABSTRACT

A vector control method for electric motors, characterized in that it comprises the steps of: supplying a reference vector (Vout_{MAX}); supplying a required vector (Vf), preferably represented by means of a real vector component (Vq) and an imaginary vector component (Vd); comparing the magnitude (V_{MAX}) of said reference vector (Vout_{MAX}) with the magnitude of said required vector (Vf), generating at least one result (V₆, index_clip) that expresses the relationship existing between said magnitudes; generating a reduction value (J) as a function of the result (V₆, index_clip); and generating a clipped value (Vf_{CLIP}) by limiting the magnitude of the required vector (Vf) as a function of the reduction value (J) and maintaining the phase of the clipped value (Vf_{CLIP}) unaltered with respect to the phase of the required vector.

### TECHNICAL FIELD

The present invention relates to a vector control method for electric motors, in particular for axial flux permanent magnet (AFPM) electric motors.

### BACKGROUND ART

As known, electric motors can be classified in direct current motors and alternating current motors according to the power supply type. In particular, alternating current motors may be divided into synchronous and asynchronous motors. Electric motors of this type are generally three-phase motors and may interface with a direct current power supply network by means of voltage converters or inverters, adapted to convert direct input voltage into alternating output voltage, the width and frequency of which are generally to be adjusted. Converters implemented by means of switches (e.g. diodes, transistors, thyristors, IGBT, etc.) may be used, the opening and closing of which is controlled so as to obtain the desired conversion. For example, an applied voltage, Pulse-Width Modulation (PWM) inverter may be used.

In particular, Pulse-Width Modulation (PWM) voltage inverters may be used in Axial Flux Permanent Magnet (AFPM) motor control systems for both propulsion and traction. In this case, the current is controlled in the motor phases by means of current regulators synchronously referenced with the rotor, and the inverter switches are PWM-controlled to obtain the desired voltage application. FIG. 1 shows a block chart, which describes a general electric motor. Thus, in general, we can affirm that the torque (block 3) depends, with variable relations according to the motor type, on a current (block 2). The torque acts on the mechanical load, thus varying the motion of the rotor and thus the speed (block 4). The motion of the rotor causes the onset of a counter-electromotive force (fcem) in the windings which tends to oppose the cause which generates it. In order to apply the desired current, a modulation is carried out to obtain a voltage injected into the motor phases comprising a contribution which should firstly overcome the counter-electromotive force (block 5). Further voltage contributions (described below) are such to force the desired current. More in detail, the desired current is given by the vector sum of: a contribution for cancelling the counter-electromotive force V_{fcem}, proportional in amplitude to the rotation speed of the motor and the object of which is to match the induced counter-electromotive force instant by instant; a torque management contribution RIf, proportional to the actual torque request that the motor should fulfill and to the motor winding impedance value, managed instant by instant by modes such as to generate the desired current, by voltage-driving the real impedance of the motor windings, in order to generate the required torque for the specific application; and a flux management contribution −jωLIf, applied with a phase such as to ensure the total flux control of the machine (i.e. the flux generated by the rotating permanent magnets plus the flux generated by the appropriate phase driving of the stator coils), managed instant by instant so as to generate, by voltage-driving the imaginary impendence of the motor windings, a current which maintains the relative orientation of the vectors and thus the level of magnetic flux of the machine unaltered.

According to a vector representation, FIG. 2 shows a desired voltage vector Vf, obtained from the vector sum of a real vector component Vq (component on real axis [symbol] given by V_{fcem}+RIf) and an imaginary vector component Vd (component on imaginary axis ℑ given by −jωIf). The desired voltage vector Vf is further characterized by a proper phase p with respect to the synchronous rotor reference. The obtained current (in the absence of field weakening when the voltage application is correct) remains on the real axis [symbol] , although the applied voltage is generally also provided with a component along the imaginary axis ℑ.

As known, the input of interface inverters between the motor and the power supply network may be a direct voltage source V_{AL}, also known as dc-link, usually obtained by the power supply network (one phase or three phase network) by means of a rectifier and leveling capacitor having appropriate capacity, adapted to maintain the direct voltage at its ends virtually constant. By means of appropriate modulation techniques, the inverter switches are switched so as to output phase voltages to the motor, the harmonic content of which comprises the fundamental harmonic (having desired frequency and amplitude) plus a series of harmonics at the switching frequency and its multiples. However, the voltage obtainable by an inverter on the load is physically limited and is a fixed fraction of the dc-link voltage V_{AL} (possible phenomena related to voltage pulse interferences, such as those due to the rapid disconnection of inductive loads, are excluded from the disclosure because of no interest for the purposes of the present invention). The desired voltage vector Vf is obtained by summing the real vector component Vq and the imaginary vector component Vd, obtained by applying the entire dc-link voltage V_{AL} for a given time T, thus achieving a linear combination in the time domain of the two vectors closest to the desired voltage Vf (these vectors are intended close to the desired voltage vector Vf in the space of the possible state configurations of the inverter switches, i.e. the vectors chosen among those vectors obtainable by stable combinations of turned-on or turned-off switches).

As shown in greater detail in FIG. 3, the applied voltage vector V₀ is obtained as the sum of a pair of vectors R and S, the meaning of which is that the dc-link voltage V_{AL} is entirely applied onto the indicated phase, but over a calibrated time which is a submultiple of the cycle time and equal in percentage to the relationship between the magnitudes of the two projections on the axes R and S with the magnitude of the dc-link voltage V_{AL}. It is thus obvious that in normal control systems, the dc-link voltage V_{AL} needed for calculating the switching timing of the inverter switches should be known to obtain the desired voltage vector Vf.

Since the dc-link voltage V_{AL} is to be known, the measurement of the dc-link voltage is very important for the control quality. In the known systems, the supply voltage of the dc-link V_{AL} is typically measured by using a remote, galvanically insulated voltage regulator. In general, such an element is active, separately supplied with direct voltage, and reads the instantaneous voltage value of the dc-link through a galvanic insulation barrier, due to the high direct and pulse voltages transiting on the dc-link itself, transforms it into a proportional current or voltage value according to a reduction factor which is, at that point, referable to the mass of the control or in general directly measurable by an analog/digital converter. Many problems both practical and of reliability however exist, such as for example dimensions, weight, vibration resistance, repeatability of measurements, separate power supply quality, filtering quality to reduce the EMC noise and breakage of the remote voltage measurer which could cause an immediate, irreparable functional decay of the motor control system.

Therefore, as mentioned, it results that because the required voltage on the load should take into account the contributions V_{fcem}, RIf and −jωLIf, and the dc-link voltage V_{AL} is limited, there are conditions in which the motor cannot be controlled as described because, provided a maximum available dc-link voltage V_{AL}, the vector sum of the contributions V_{fcem}, RIf and −jωLIf is higher than the maximum voltage obtainable on the load. In these cases, the machine control cannot be maintained and the motor stops. Techniques of known type include, for example, using the reading of the dc-link voltage V_{AL} or determining the modulation index of the switches (e.g. IGBT) of the inverter, or a combination of the two elements for calculating a field weakening level of the machine so as to ensure that the voltage margins needed for synchronizing and controlling the torque current are respected instant by instant. A phase error of the applied voltage thus occurs, which also induces a phase error in the developed current. In practice, when this occurs, the obtained voltage/current balance control is lost (balance between applied voltage, electromotive force, voltage drop on phase inductances, voltage drop on phase resistances, etc.). It is known that field weakening of the machine is theoretically possible to return the required voltage vector within the maximum magnitude whenever needed, but this approach has a number of known drawbacks. For example, beyond a given limit, field weakening is not possible in the permanent magnet machine, and furthermore the effect of the field weakening action is not immediate, but has dynamics which depend on constructional factors of the machine. Therefore, a possible sudden decrease of the dc-link voltage V_{AL} faster that the correction dynamic cannot be corrected. In both cases, if the corrective action is not timely successful, the motor abruptly stops because synchronization with power supply voltage is lost. At least two effects are thus immediately generated: the supplied torque is instantaneously zero, with abrupt torsional mechanical reactions of the whole mechanical system; and the electromotive force, which is connected to the rotation speed, becomes instantly zero, with electromagnetic field/voltage/current reactions typically generating very high currents in the inverter switches and maximum current protection activations.

These effects are to be carefully avoided in order to ensure system integrity and maintain service continuity.

### DISCLOSURE OF INVENTION

It is the object of the present invention to provide a vector control method for electric motors which is free from the drawbacks of the prior art.

According to the present invention, a vector control method for electric motors is provided as defined in claim 1.

### BRIEF DESCRIPTION OF THE DRAWINGS

For a better understanding of the present invention, a preferred embodiment will now be described only by way of non-limitative example, and with reference to the accompanying drawings, in which:

FIG. 1 shows a block chart of a general electric motor of known type;

FIG. 2 shows a vector representation of the components which intervene in defining the voltage injected in the phases of an electric motor of known type;

FIG. 3 shows a vector representation of the components which intervene in defining the voltage injected in the phases of an electric motor in an applied voltage, three-phase system of known type;

FIG. 4 shows a clipping device of the components which intervene in defining the voltage injected in the phases of an electric motor according to the present invention;

FIG. 5 shows a vector representation of the components which intervene in defining the voltage injected in the phases of an electric motor according to the present invention;

FIG. 6 shows a flow chart which describes the operation of the clipping device in FIG. 4;

FIGS. 7-9 show respective logic circuits of the device in FIG. 4;

FIG. 10 shows a mapping curve of the magnitudes in the logic circuit in FIG. 9;

FIG. 11 shows a further logic circuit of the device in FIG. 4; and

FIG. 12 shows a first numerical example of the operations carried out by the logic circuit in FIG. 8; and

FIGS. 13 and 14 show a second numerical example of the operations carried out by the logic circuits in FIGS. 8 and 9.

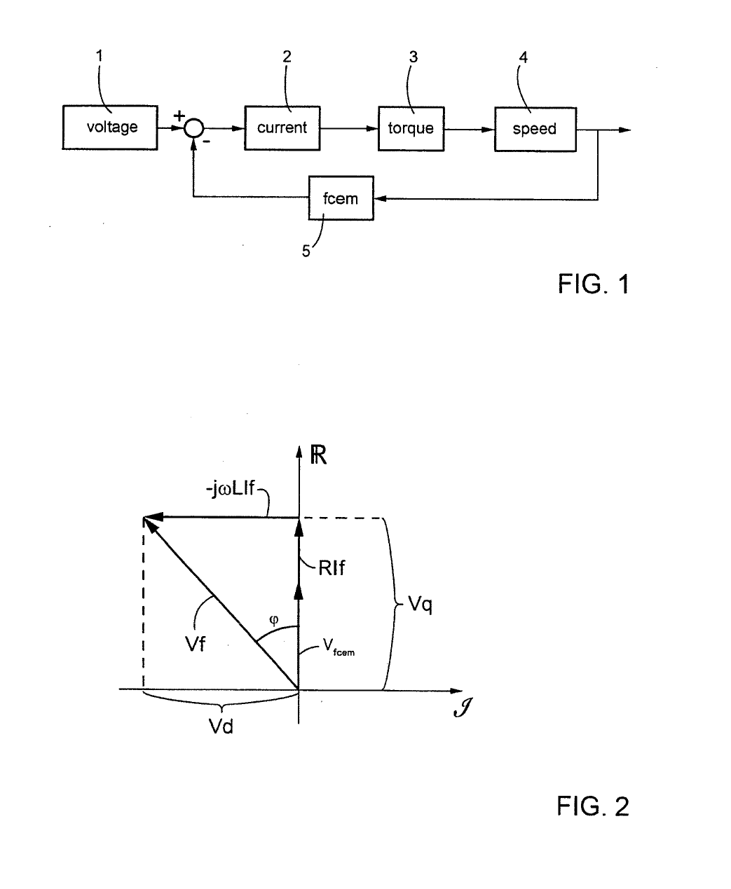

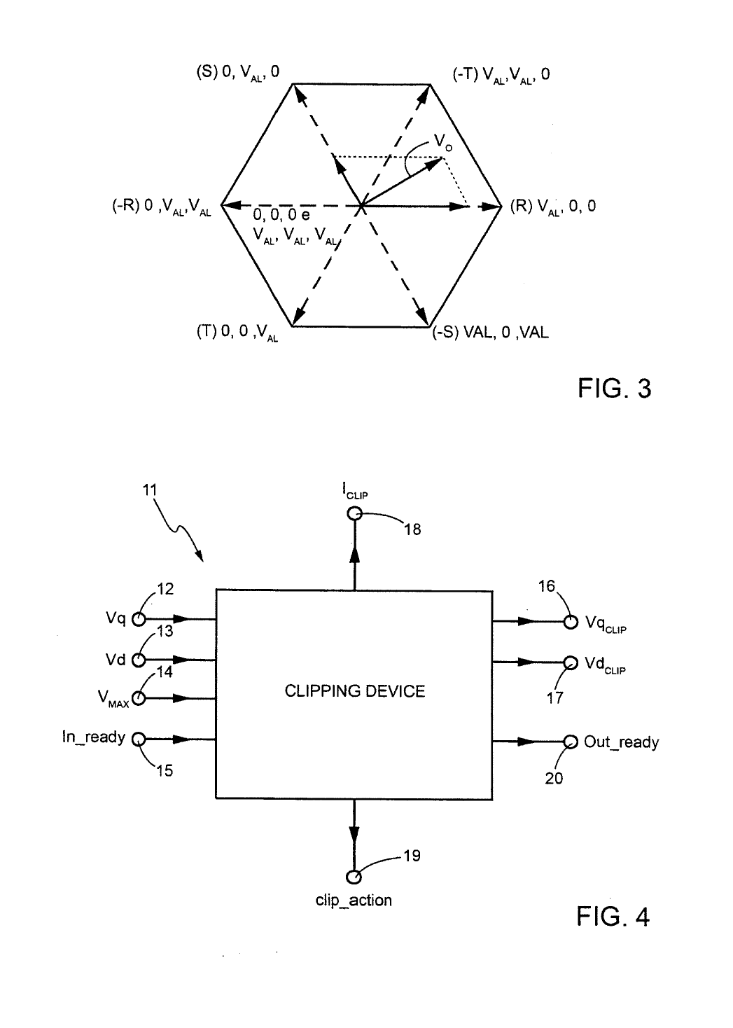

### BEST MODE FOR CARRYING OUT THE INVENTION

FIG. 4 shows a clipping device 11, adapted to work as a peripheral device of a digital control processor (not shown) configured to receive an input voltage vector related to a required voltage and to output a voltage vector related to an actually obtainable voltage, either by adapting or reducing the magnitude of the input vector while maintaining the phase unaltered, as better illustrated hereinafter.

The digital control processor has the task of running calculations related to the motor control system (regulators, online templates, gains, etc.), and interfaces with the clipping device 11, for example by means of I/O digital ports for data exchange.

The clipping device 11 is configured to accept at input a real required vector component Vq (vector component on real axis [symbol] expressed by V_{fcem}+RIf) and an imaginary required vector component Vd (vector component on imaginary axis ℑ expressed by −jωLIf), respectively on a first and a second input ports 12, 13.

Advantageously, the clipping device 11 may further accept a maximum voltage value V_{MAX} at input on a third input port 14, which represents the magnitude of a maximum voltage vector Vout_{MAX} obtainable on the load (possibly directly expressed in proportional terms with respect to the effect of the application of maximum depth of the PWM modulation on a typical dc-link value) and on a fourth input port 15, a first synchronization command In_ready, to command the processing start-up when the inputs (the real and imaginary required vector components Vq, Vd and the maximum voltage value V_{MAX}) on the input ports 12-14 are stable.

The clipping device 11 outputs a real adapted vector component Vq_{CLIP} and an imaginary adapted vector component Vd_{CLIP}, generated on the basis of the required real and imaginary vector components Vq, Vd, on a first and a second output ports 16, 17 respectively, as described in greater detail below. The clipping device 11 further outputs, on a third output port 18, a current vector I_{CLIP}, which represents the current error on the imaginary axis ℑ (in particular, the current vector I_{CLIP} represents the difference between the adapted current vector on the imaginary axis in that moment and the current vector which would be applied to field weakening the motor and return the required vector within the feasibility threshold); a clip_action command, on a fourth output port 19, to communicate that the clipping device 11 is working, i.e., is in a vector-adapting phase; and a second synchronization command Out_ready, asserted on a fifth output port 20 when the data on the outputs 16-18 (the real vector component and the imaginary vector component Vq_{CLIP} and Vd_{CLIP} and the current vector I_{CLIP}) are stable and may be read.

The clipping device 11 may comprise an internal memory (not shown), adapted to store a plurality of parameters or constants, useful for the operation of the clipping device 11 itself, as described in greater detail below. These parameters or constants may be stored during the manufacturing process of the clipping device 11 or later on, indifferently.

As mentioned, the clipping device 11 may advantageously interface with a digital control processor, configured to run calculations related to the motor control system, by controlling, for example, the current regulators and defining the PWM control modulation of the electronic switches of the inverter, on the basis of data (in particular on the basis of the real adapted vector component Vq_{CLIP} and the imaginary adapted vector component Vd_{CLIP}) received by the clipping device 11. The control carried out by the digital processor is thus based on the data processed by the clipping device 11. In practice, the clipping device 11 does not generate the working voltages required by the electric motor itself but defines values proportional to the working voltages and functional to the inner actuation logics of the motor control system. In particular, these values are later used by the digital processor for controlling the current regulator and define the PWM control modulation of the inverter.

On this basis, it is apparent that the maximum voltage value V_{MAX} does not express the power supply value V_{AL} measured on the dc-link, but it expresses a proportional value, possibly minus an offset, at the maximum amplitude which the inverter, e.g. PWM-controlled, can actually generate in terms of percentage of the effective voltage in that moment present on the dc-link, for any effective value such a voltage may take in that given moment. The maximum voltage value V_{MAX} thus defines a limit value with respect to the variability used in determining the conducting/non-conducting control timing of the electronic switches forming the inverter, which limit value may not be exceeded for reasons related to the physical construction of the inverter itself. The request to generate on the load a maximum voltage value equal to a V_{MAX} thus equals the request to generate 100% of the available power supply voltage V_{AL}, independently from the effective value of such a voltage.

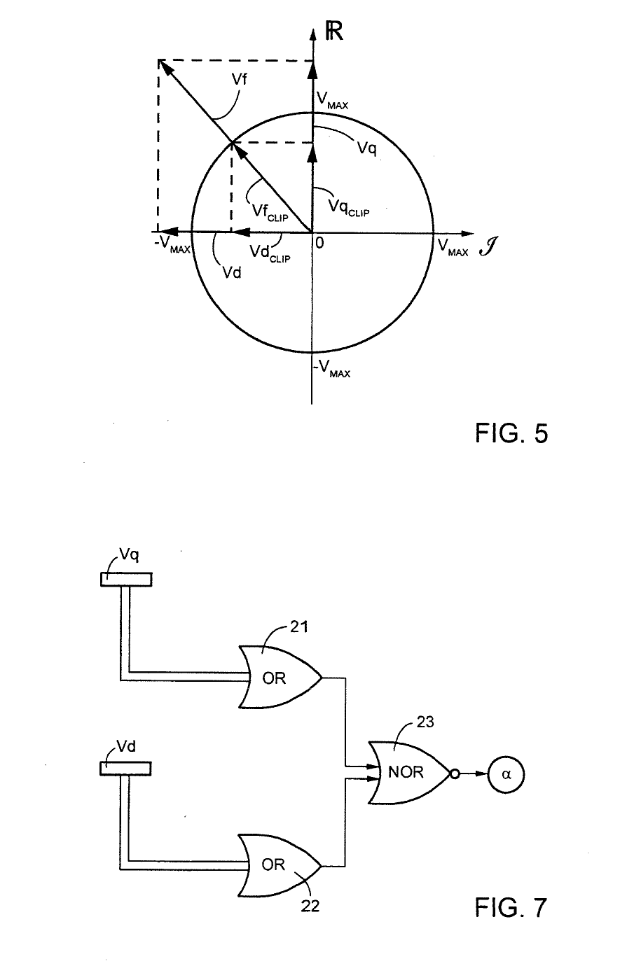

Similarly, the real and imaginary required vector components Vq, Vd, as well as the real and imaginary adapted vector components Vq_{CLIP} and Vd_{CLIP}, are not voltages in strict sense, but identify values proportional, possible minus an offset, to the width that the inverter, e.g. PWM-controlled, should effectively obtain in terms of percentage of the effective voltage present in that moment on the dc-link, for any effective value such a voltage takes in that given moment. These values are translated in fact by the control system into timed on/off commands of the electronic switches of the inverter, so as to obtain required voltage supplied according to that shown by means of the components on the real and imaginary axis according to the representation in FIG. 2 and FIG. 5.

FIG. 5 shows a required vector Vf, broken down into its real and imaginary required vector components Vq and Vd, which exceeds a threshold value, given by the maximum voltage value V_{MAX}, shown in FIG. 5 by the distance between the centre of axes O and the points laying on the circumference of a maximum circle 24. As apparent in FIG. 5, the required vector Vf, resulting from the vector sum of its components of the real (component Vq) and imaginary (component Vd) axis, is higher than the magnitude of the maximum voltage V_{MAX}. In case of request of a required vector Vf having magnitude higher than the maximum voltage value V_{MAX}, the clipping device 11 outputs an adapted vector Vf_{CLIP}, with reduced magnitude with respect to the magnitude of the required vector Vf, in particular having magnitude equal to the magnitude of the maximum voltage vector Vout_{MAX}, given, as mentioned, by the maximum voltage value V_{MAX}, and phase equal to the required vector phase Vf. The synchronization of the control system of the machine is, in this manner, stable. Furthermore, in this case, the clip_action command is activated, so as to signal that the clipping device 11 is adapting the required vector Vf (it is in the vector-adapting phase). As a further consequence of the activation of the clip action command, activation of the antiwindup system is commanded, in order to avoid the generation of integration errors due to the saturation of the current regulators.

In parallel to calculating the adapted vector Vf_{CLIP}, the clipping device 11 further outputs the current vector I_{CLIP}. Optionally, the current vector I_{CLIP} may be input to the field weakening regulator, thus directly driving the field weakening regulator, which, by means of a dynamic defined by the machine constants, allows to gradually return the magnitude of the required vector Vf within the maximum circle 24, thus contributing to obtaining the adapted vector Vf_{CLIP}.

In detail, the action of the clipping device 11, which leads to obtaining the clipped adapter Vf_{CLIP}, reduces the amplitude of the required vector Vf and returns it within the maximum circle 24 maintaining the phase unaltered. When the field weakening action driven by the current vector ICLIP becomes significant, the voltage Vfcem is reduced and a balance is obtained; therefore the required vector Vf is obtainable with a reduced cutting of its vector components (by virtue of the field weakening which reduces the effect of the counter-electromotive force, which removes dynamics from the possible width variation of the vector). In practice, cycle after cycle, the field weakening increases and the need for adaptation gradually decreases (i.e. the need for an adaptation of the amplitude of the required vector Vf for taking it below the maximum allowed value is reduced).

The driving of the field weakening regulator may not be necessary if the field weakening is already maximum with respect to manufacturing specifications, or if it is deactivated for particular reasons. In these cases, maintaining the phase and reducing the magnitude of the required sum vector Vf to obtain the adapted sum vector Vf_{CLIP} are sufficient to ensure operating regularity of the machine.

With regards to action sequencing, the clipping device 11 may work on two different time levels. In real time there is a reduction of the required sum vector magnitude Vf within the maximum circle 24 maintaining the phase constant, a saturation signaling to the current regulators and a blocking of the current regulator wind-up. Optionally, at a deferred time, a field weakening modulation causes a gradual return of the magnitude of the required vector magnitude Vf within the maximum circle 24 with a certain time constant τ, which depends on the electric machine in which the clipping device 11 works (e.g. the time constant τ may have a value in the order to 100-1000 times the required vector-adapting time).

The processing speed of the clipping device 11 depends on the speed of the processor used (clock speed). The minimum operating cycle time effectively obtainable obviously depends on the manufacturing technology used. In particular, a speed so as to allow the completion of a calculation cycle in an interval of time comprised between 20 and 200 μs is acceptable for the machines most commonly used in industrial practice.

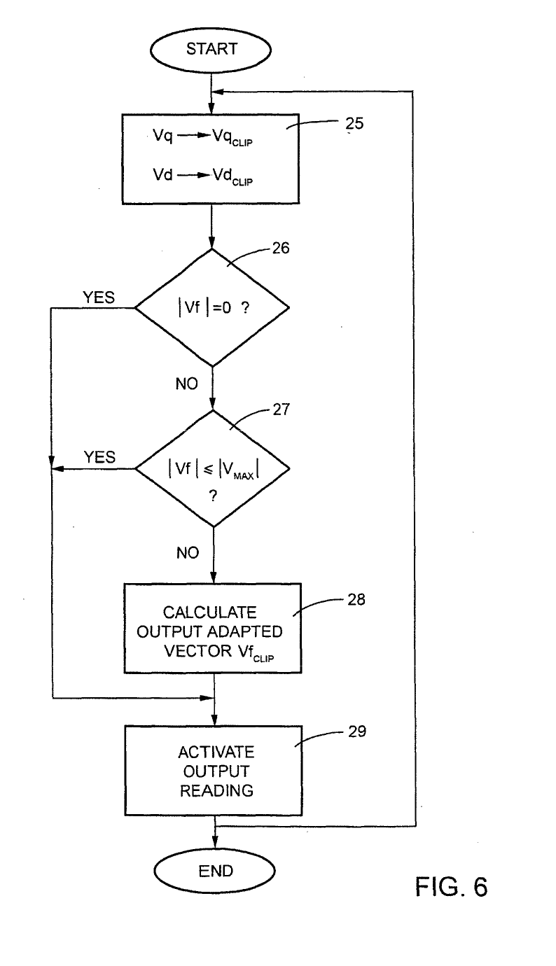

The operation of the clipping device 11 is explained in greater detail below with reference to FIGS. 6-9.

FIG. 6 shows a flow chart illustrating the sequence of operations for calculating the adapted vector Vf_{CLIP}.

Firstly, step 25, the real and imaginary required vector components Vq, Vd, input to the clipping device 11 on first and second input ports 12, 13, are asserted, unaltered, on first and second output ports 16, 17.

Thus, step 26, it is checked whether the magnitude of the required vector Vf is zero (e.g. it is checked whether both real and imaginary required components Vq, Vd are different from zero). If the result of the check is positive, and thus the required vector module Vf is zero, further processing is not necessary and the real and imaginary required vector components Vq and Vd on the respective input ports 12, 13 correspond to the real and imaginary adapted vector components Vg_{CLIP}, Vd_{CLIP} previously asserted on the respective first and second output port 16, 17, as described with reference to step 25. In this case, there is a transition to step 29, in which the second synchronization command Out_ready is asserted on the fifth output port 20, thus signaling that the data on the output ports 16, 17 may be read and preparing the clipping device 11 to accept a subsequent input value on the input ports 12, 13.

Later, step 27, if the real and imaginary required vector components Vq, Vd are not zero, it is checked whether the required vector magnitude Vf is lower than or equal to the maximum voltage value V_{MAX}. If the maximum voltage value V_{MAX} is higher than the magnitude of the required voltage vector Vf, output YES from step 27, further processing is not necessary because the power supply voltage is sufficient to allow to obtain the required voltage vector Vf (the required voltage vector Vf is within the maximum circle 24 in FIG. 5). Thus, the real and imaginary vector components Vd and Vq asserted on outputs 16 and 17 (step 25) may be read.

If instead the maximum voltage value V_{MAX} is lower than the magnitude of the required voltage vector Vf, output of step 27, the real and imaginary vector components Vd and Vq on first and second output ports 16, 17 are not read. Therefore, the processing continues because the power supply voltage is sufficient to obtain the required voltage vector Vf (the vector Vf is external to the maximum circuit 24 in FIG. 5). The clip action command is activated to communicate to the digital control processor that the step of vector-adaptation is in progress. The digital control processor takes this information into account when controlling the current regulators.

Therefore, step 28, the adapted vector Vf_{CLIP} is calculated, by calculating the real adapted vector component Vq_{CLIP} and imaginary adapted vector component Vd_{CLIP}.

Advantageously, the real adapted vector component Vg_{CLIP} may be obtained by using the following equation (1):

$${Vq}_{CLIP} = Vq \cdot \sqrt{\frac{{V}_{MAX}^{2}}{{Vq}^{2} + {Vd}^{2}}} , \qquad ( 1 )$$

while the imaginary adapted vector component Vd_{CLIP} may be obtained by using the following equation (2):

$${Vd}_{CLIP} = Vd \cdot \sqrt{\frac{{V}_{MAX}^{2}}{{Vq}^{2} + {Vd}^{2}}} . \qquad ( 2 )$$

The value given by \sqrt{V_{MAX}²/(Vq²+Vd²)} thus fulfils the function of reduction or cutting factor for the real and imaginary vector components Vq and Vd.

Other reduction factors may be used at the discretion of the designer or on the basis of experimentation, e.g. by applying a logarithmic function, a sigmoid function or an approximation by means of an appropriate numeric series.

Finally after having calculated the adapted vector Vf_{CLIP} the method goes onto step 29. Similarly, as already mentioned, the second synchronous command Out_ready is asserted on the fifth output port 20 of the clipping device 11 to signal that the output port data 16, 17 (i.e. the real adapted vector component Vq_{CLIP} and the imaginary adapted vector component Vd_{CLIP}) can be read.

The described steps 25-29 may be repeated for new real and imaginary required vector component values Vq and Vd input to the clipping device 11.

FIG. 7 shows in detail a possible implementation of a logic circuit, which carries out the described operations with reference to step 26 in FIG. 6.

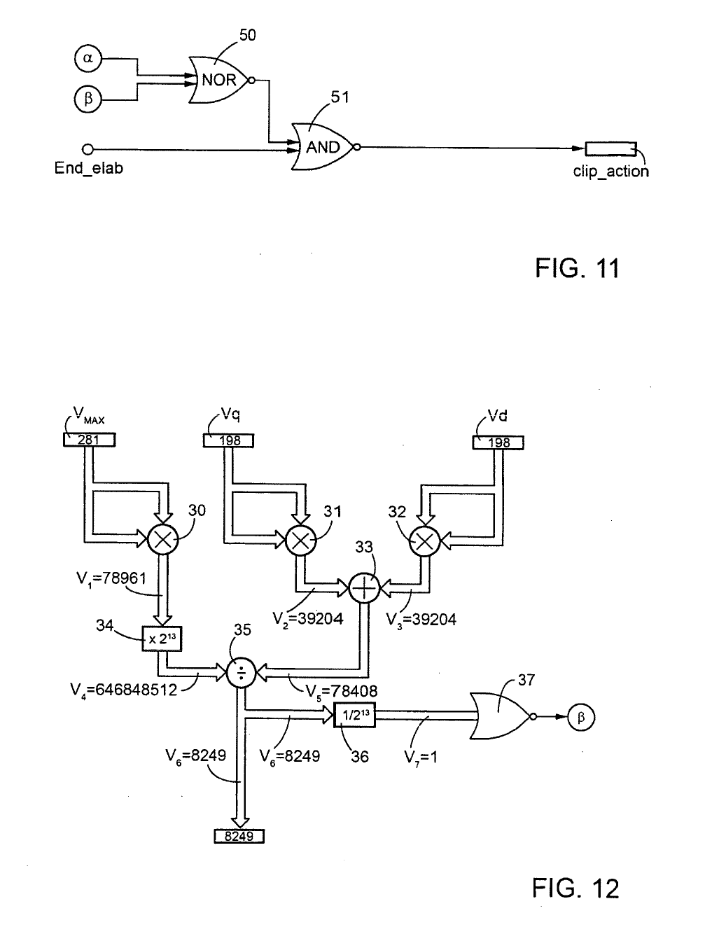

The real and imaginary required vector components Vq, Vd, shown, for example, in binary logic as strings of N bit, are input to a respective OR logic port 21, 22, which carries out a bit to bit OR operation of the respective string. The output of each OR logic port 21, 22 has a low logic value only if all the bits of the input string have a low logic value (i.e. if both real and imaginary required vector components Vq and Vd are zero). Therefore, the outputs of the logic OR port 21, 22 are in turn input to a NOR logic port 23, the output of which takes high logic value only if both the outputs of the two OR logic ports both have low logic value. If the output of the NOR logic port 23 is high it means that the required vector Vf is zero and further processing is not needed. The output of the NOR logic port 23, indicated by α, is used as described in greater detail below with reference to FIG. 11.

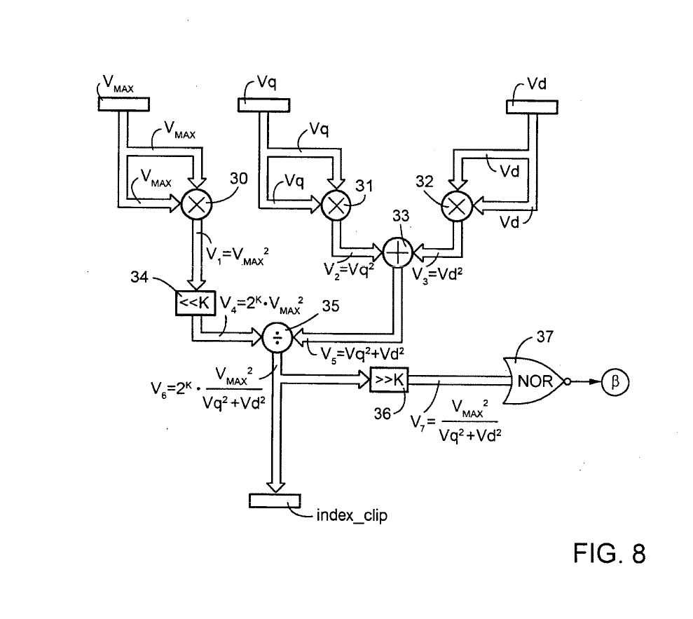

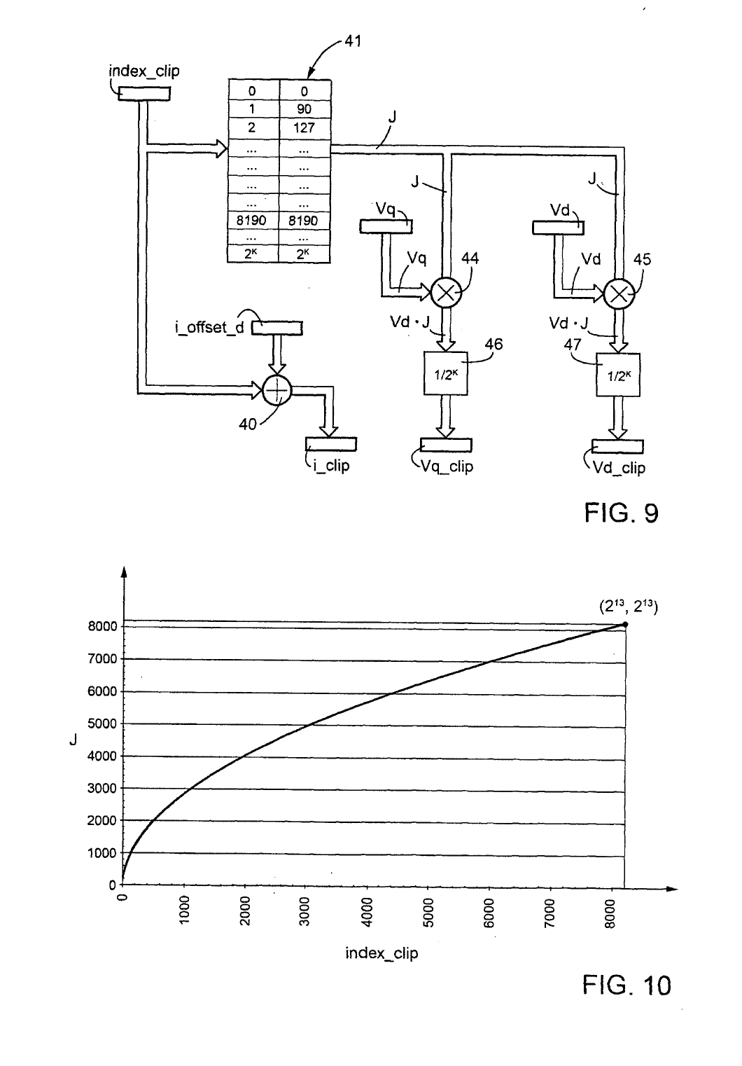

FIGS. 8 and 9 show in detail a possible implementation of a logic circuit which implements steps 27 and 28 of FIG. 6.

According to an embodiment of the present invention, the numeric value of the real and imaginary vector components Vq and Vd may be, for example, represented in a binary system by means of a string of N bits, in integer mathematics. In particular, both the maximum voltage value V_{MAX} input to the clipping device 11 and the real and imaginary required vector components Vq, Vd may be represented using a integer binary logic by means of strings of N bits.

In detail, the real and imaginary required vector components Vq, Vd and the maximum voltage value V_{MAX} are input to a respective multiplier 31, 32, 30, which carries out a operation of squaring. Each vector component Vq, Vd and the maximum voltage value V_{MAX} are indeed multiplied by themselves, to output the vector components squared V₂=Vq², V₃=Vd² and the value V₁=V_{MAX}² from the multipliers 31, 32, 30. After such an operation, the vector components squared Vq², Vd² and the value V_{MAX}² are advantageously represented by means of strings of 2N bits to prevent possible loss of information.

Therefore, the vector components squared V₂=Vq² and V₃=Vd² output from multipliers 31 and 32 are added to one another by means of the adder 33, which generates the output value V₅=Vq²+Vd². The value V₁=V_{MAX}² is multiplied by a constant 2^{K}. In binary logic, the latter operation may be implemented by a shift block 34, which shifts the bits of the string which represents the value V₁=V_{MAX}² leftwards by K positions.

This is equivalent to multiplying the value V₁=V_{MAX}² by 2^{K}, obtaining V₄=2^{K}·V_{MAX}².

The value V₄=2^{K}·V_{MAX}² is then divided by the value V₅=Vq²+Vd² by means of a divider 35, obtaining in output from the divider 35 the value V₆=2^{K}·V_{MAX}²/(Vq²+Vd²), represented on 2N bits.

The value of K may be chosen according to execution accuracy of the division, generated by the divider 35, in integer mathematics, which is desired to be obtained (freely chosen by the designer). For example, in order to ensure at least a division accuracy in integer mathematics of a part on 1024, K is chosen equal to 10. For an accuracy of approximately one part per million, K is chosen equal to 20.

Then, the N least significant bits are extracted from the value V₆ output by divider 35, forming a clipping index index_clip. This operation does not cause loss of information because the division operation implemented by the divider 35 reduces the value of V₆ within a range of values which can be represented on N bits.

Furthermore, the value V₆ output by the divider 35 is input to a shift block 36, which shifts rightwards by K positions, factually dividing such a value by 2^{K} and obtaining the value V₇=V_{MAX}²(Vq²+Vd²). Similarly, as described with reference to the shift block 34, also in this case the value K may be chosen equal to 13. The value V₇ is in turn input to a NOR logic port 47 for a bit to negated bit OR operation (output of the NOR logic port 47, indicated by β, is used as shown below with reference to FIG. 11).

FIG. 9 shows the operations subsequent to those described with reference to FIG. 8, to obtain the real and imaginary adapted vector components Vq_{CLIP}, Vd_{CLIP} and the current vector I_{CLIP}. In particular, the current vector I_{CLIP} is calculated by adding, by means of the adder 40, the clipping index index_clip to a field weakening compensation parameter i_offset_d, the value of which, comprised in the range (−2^{K}, . . . , +2^{K}), depends on the field weakening regulator design (which is not the object of the present invention).

In particular, the field weakening compensation value i_offset_d depends on the numeric range (number of bits) that the field weakening regulator accepts as input and has the function of shifting the value of the clipping index index_clip in the operating range of the field weakening regulator.

In practice, it is advantageous to obtain an output which is interpreted as zero by the field weakening regulator when the field weakening system creates a balance considered appropriate by the designer, in order not to further stimulate field weakening. This choice obtains a balance point between two phenomena which intervene in the same direction: field weakening and vector-adaptation, that the designer can modulate according to the working point.

In parallel to the operations for calculating the current vector I_{CLIP}, processes are carried out to process the real and imaginary adapted vector component Vq_{CLIP},Vd_{CLIP}. More in detail, the clipping index index_clip is input to a reduction table 41, comprising 2^{K} fields, each field containing a reduction value J comprised in the range (0, . . . , 2^{K}). The value taken by the clipping index index_clip is used to address a respective field of the reduction table 41. The reduction values J contained in the subsequent fields of the reduction table 41 takes an increasing value according to an appropriate law, e.g. as shown in FIG. 10, the reduction values J contained in the reduction table 41 advantageously increase according to a function f(index_clip) of the square root type comprised in the range of values (0, . . . , 2^{K}). For example, the function f(index_clip) may be given by J=f(index_clip)=\sqrt{2^{K}·index_clip}. In the specific example in FIG. 10, the value of K is equal to 13.

As previously described with reference to equations (1) and (2), other functions may be used at the designer's discretion or on the basis of experimentation, such as for example a logarithmic function, a sigmoid function or an approximation by means of an appropriate numeric series having a trend similar to the function in FIG. 10. Other functions may be used, possibly such as to locally introduce linear or non linear variations to the square root function in FIG. 10.

Given a clipping index index clip, the reduction table 41 outputs a respective reduction value J, represented in binary logic on N bits. The reduction value J is multiplied by means of the multipliers 44, 45, by the real and imaginary required vector components Vq, Vd, to obtain values Vg=JVq and V₁₀=JVd. The values V₉ and V₁₀ are appropriately represented on 2N bits, to avoid possible loss of information.

The value V₉=JVq is then divided by a constant 2^{K} (e.g. by K=13 coherently to the previous description) by means of the divider 46. Dependence from the constant 2^{K} introduced during the previously described operation is thus eliminated. The string thus obtained can be represented again using N bits without loss of information. For this purpose, the least significant bits N are taken from the string V₉ and the most significant bits N are rejected (the latter all with logic value zero), thus obtaining the real adapted vector component Vq_{CLIP}.

Similarly, to obtain the imaginary adapted vector component Vd_{CLIP}, the value V₁₀=JVd output by multiplier 45 is divided by 2^{K} by means of the divider 47. Thus, the obtained value is represented using N bits without loss of information, by taking the least significant bits N and rejecting the most significant bits N. The imaginary adapted vector component Vd_{CLIP} is thus obtained.

When the data (e.g. digital) representing the imaginary adapted vector component Vd_{CLIP}, the real adapted vertor component Vq_{CLIP} and the current vector I_{CLIP} are stable on the respective outputs, an end of processing signal End_Elab is generated by a management logic (not shown) inside the clipping device 11.

FIG. 11 shows a logic diagram for calculating the clip_action command, in order to evaluate whether the clipping device 11 is executing the vector-adaptation. In detail, a NOR logic port 50 receives on a first input the output value of the NOR logic port 23 in FIG. 7 (indicated by α) and on a second input thereof the output value of the NOR logic port 37 in FIG. 8 (indicated by β), to output a high logic value (logic 1 logic) only if both inputs are zero, i.e. if real and imaginary required vector components Vq, Vd are zero and if the magnitude of the required vector Vf exceeds the maximum voltage value V_{MAX}.

Therefore, the output of the NOR logic port 50 is input to an AND logic port 51, along with the end of processing signal End_Elab. In the example shown in figure, the end of processing signal End_Elab take high logic value during the step of clipping and signals end of the step of clipping taking a low logic value.

The output of the AND logic port 51, which represents the action command clip_action takes high logic value only if both inputs have a high logic value, signaling that the step of clipping is occurring.

FIG. 12 shows a numeric example of the steps described with reference to FIG. 8, in the case in which the real and imaginary required vector components Vq, Vd do not require clipping (with reference to the representation in FIG. 5, the required vector Vf is within the maximum circle 24).

A decimal base instead of a binary representation will be used hereinafter for better clarity and description simplicity. Furthermore, because the method uses integer type values, possible decimal digits will not be taken into consideration.

In this example, the maximum voltage value V_{MAX} is equal to 281, the real required vector component Vq is equal to 198 and the imaginary required vector component Vd is also equal to 198. The magnitude of the required vector Vf, equal to 280, is thus less than the maximum obtainable voltage value V_{MAX}.

The maximum voltage value V_{MAX} is input to the multiplier 30, which in turn outputs the value V₁=V_{MAX}²=78961. Similarly, the vector components Vq and Vd are supplied to respective multipliers 31, 32 and squared, thus obtaining the values V₂=Vq²=39204 and V₃=Vd²=39204 on an output of the respective multipliers.

The value V₁ is thus input to the shift block 34, which, in decimal representation, is equivalent to a multiplier. In particular, chosen the constant K=13, the vector V₁ is multiplied by 2^{K}=2¹³, thus obtaining the value V₄=646848512. The values V₂ and V₃ are instead added to one another to obtain the value V₅=78408. The values V₄ and V₅ are thus input to the divider 35. The divider 35 divides V₄ by V₅, to output value V₆=V₄/V₅=8249. The value V₆ is thus input to the shift block 36, which divides value V₆ by 2^{K}=2¹³, thus outputting the value V₇, equal to 1. The NOR logic port 37 carries out a bit to bit OR and then the result is negated. In a binary representation, the OR bit-to-bit logic operation of any sequence of bits comprising at least one bit with high logic value (logic value 1) generates as a result a high logic value which, negated, becomes low (logic value 0). Such a logic value is thus supplied to the calculation logic in FIG. 11 which identifies whether the vector-adaptation is in execution or not. In this case, being the vectors Vd and Vq not zero and being the vector Vf feasible, the clip action command is not activated.

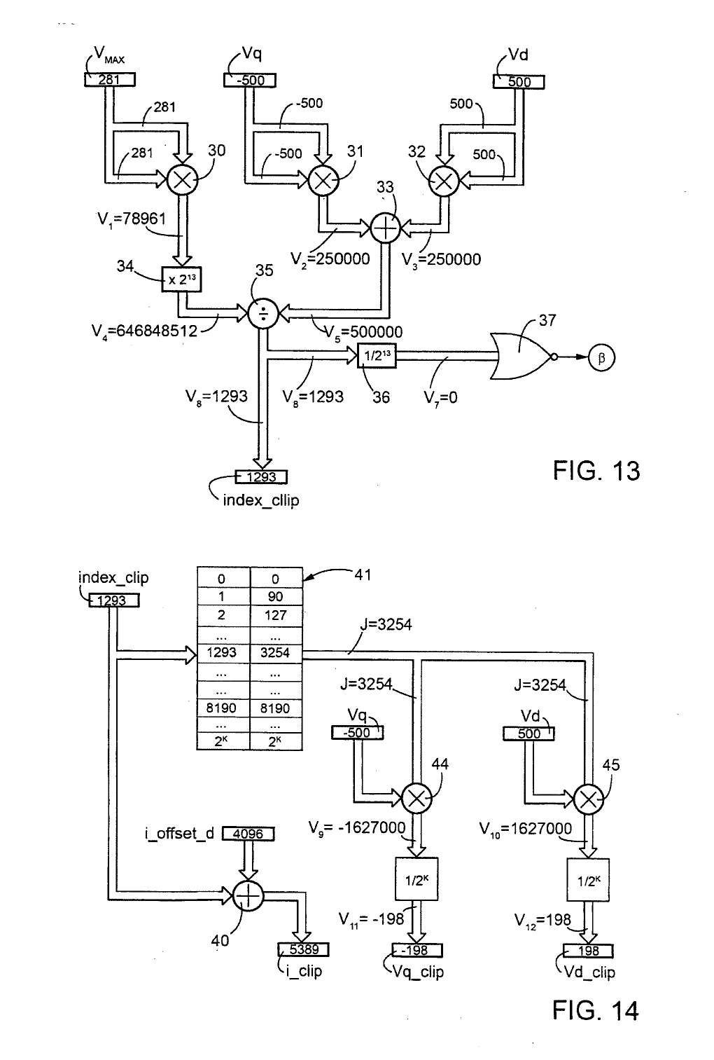

FIGS. 13 and 14 show a numeric example of the steps described with reference to FIGS. 8 and 9, in the case in which the real and imaginary required vector components Vq, Vd require clipping (with reference to the representation in FIG. 5, the required vector Vf is outside the maximum circle 24).

A decimal base instead of a binary representation will be used also in this case for the values contained in the vectors for better clarity and description simplicity. Furthermore, because the method uses integer type values, possible decimal digits will not be taken into consideration.

In this example, the maximum voltage value V_{MAX} is equal to 281, the real required vector component Vq is equal to −500 and the imaginary required vector component Vd is equal to 500. The magnitude of the required vector Vf, equal to 707, is thus higher than the maximum voltage value V_{MAX}.

The maximum voltage value V_{MAX} is firstly input to the multiplier 30, which in turn outputs the value V₁=V_{MAX}²=78961. Similarly, the vector components Vq and Vd are supplied to respective multipliers 31, 32 and squared, thus obtaining the vectors V₂=Vq²=250000 and V₃=Vd²=250000 on an output of the respective multipliers.

The vector V₁ is thus input to the shift block 34, which, in decimal representation, is equivalent to a multiplier. In particular, by choosing the value K=13, the vector V₁ is multiplied by a constant equal to 2K=2¹³, to obtain the vector V₄=646848512, input to divider 35. The vectors V₂ and V₃ are instead added to one another to obtain the vector V₅=500000, which is thus input to divider 35. The divider 35 divides V₄ by V₅, outputting vector V₆=V₄/V₅=1293. The vector V₆ is thus input to the shift block 36, which divides the vector V₆ by the constant 2^{K}=2¹³, thus outputting the vector V₇ having a value equal to 0 (as mentioned, because the method works with integral mathematics, the decimal digits are not considered). The NOR logic port 37 carries out a bit to bit OR and then the result is negated. The result of this operation is the logic value 0 also in this case. Such a value is thus supplied to the calculation logic in FIG. 11 which identifies whether the vector-adaptation is in execution. In this case the clip action command is activated and the operations proceed.

The vector V₆ is thus used as clipping index index clip.

The current vector I_{CLIP} is calculated by adding the clipping index index_clip=1293 to the field weakening parameter i_offset_d, chosen in this example equal to 4096. The current vector value I_{CLIP}, equal to 5389 is thus obtained.

Furthermore, the clipping index index_clip is used as index for accessing a respective field of the reduction table 41. In the example shown, with reference to FIG. 10, the index 1293 corresponds in the reduction table 41 to output value J=3254. Therefore, the real vector component Vq is multiple by J, obtaining the vector V₉=−1627000, and the imaginary required vector component Vd is multiplied by J, obtaining the vector V₁₀=1627000. Thus, both vectors V₉ and V₁₀ are divided by the constant 2^{K}=2¹³ thus obtaining in output from the dividers 46, 47 the vectors V₁₁=−198 and V₁₂=198, which are then supplied to the respective first and second output port 16, 17 and represent the maximum obtainable real adapted vector component Vq_{CLIP} and imaginary adapted vector component Vd_{CLIP}.

From an examination of the features of the vector control device for electric motors made according to the present invention are apparent the advantages that it allows to obtain.

The vector control method for electric motors according to the present invention may be, for example, used in a traction/propulsion system with power supply derived from a battery. In this case, a considerable problems is found when, as known, consequent to a high motor rpm operation request (high electromotive force) or in the presence of instantaneous torque requests (high current request), the power supply voltage derived by the battery may considerably decrease in time (for reasons linked to the static or dynamic feature of the battery and the level of charge of the same). Such a decrease of the power supply voltage is often unpredictable and may cause an instantaneous, and generally not restorable, stopping of the electric motor, in particular of an axial flux permanent magnet motor (AFPM), in which a request for vector voltage application request is outside a maximum feasibility circle refers to such a decreased line voltage.

The use of a clipping device implementing the vector control method according to the present invention is thus advantageous for safely managing the motor in situations of reduced voltage supplied by the battery because it ensures that the control system emits vector voltage application requests which are always perfectly obtainable as the line voltage varies (possibly decreases).

Firstly, the electric machine, e.g. axial flux permanent magnet motor (AFPM) electric machines, is always used safely within the available voltage limits and at maximum efficiency (indeed, energy is needed for field weakening only when needed and using the minimum necessary amount). In particular, with regards to applications in which the electric machine is battery powered, the operative autonomy is maximized in this manner. Furthermore, the instantaneous clipping action of the required vector ensures operating continuity with respect to even abrupt power supply voltage variations, e.g. cause by the insertion of several loads on the line. Finally, knowing the dc-link value is not necessary. A critical sensor which would be needed to supply high quality information is therefore eliminated.

It is finally apparent that changes and variations can be made to the vector control device for electric motors described and illustrated without departing from the scope of protection as defined in the accompanying claims.

For example, the operations described with reference to FIGS. 7-9 and 11 can be implemented in analog electronics.

1. A vector control method for electric motors, characterized in that it comprises the steps of:
supplying a reference vector (Vout_{MAX});
supplying a required vector (Vf), said required vector being preferably represented by means of a real vector component (Vq) and an imaginary vector component (Vd);
comparing the magnitude (V_{MAX}) of said reference vector (Vout_{MAX}) with the magnitude of said required vector (Vf), generating at least one result (V₆, index_clip) that expresses the relationship existing between said magnitudes;
generating a reduction value (J) as a function of said result (V₆, index_clip); and
generating a clipped value (Vf_{CLIP}) by limiting the magnitude of said required vector (Vf) as a function of said reduction value (J) and maintaining the phase of the clipped value (Vf_{CLIP}) unaltered with respect to the phase of the required vector.

2. The method according to claim 1, further comprising the step of verifying whether said required vector (Vf) has a magnitude different from zero;
said verification step being carried out before said comparison step and enabling said next comparison step in the case of successful verification.

3. The method according to claim 1, wherein said comparison step comprises the steps of:
squaring the magnitude (V_{MAX}) of said reference vector (Vout_{MAX});
multiplying said squared magnitude of said reference vector by a first parameter (2^{K}) to obtain a first intermediate value (V₄);
squaring said real vector component (Vq) and said imaginary vector component (Vd);
adding said squared real vector component (Vq) to said squared imaginary vector component (Vd) to obtain a second intermediate value (V₅); and;
dividing said first intermediate value (V₄) by said second intermediate value (V₅) to obtain said result (V₆, index_clip) that expresses the relationship existing between said magnitudes.

4. The method according to claim 3 and further comprising the steps of:
normalizing said result (V₆, index_clip) with respect to said first parameter (2^{K}) to obtain a third intermediate value (V₇);
verifying whether said third intermediate value (V₇) is greater than or equal to unity; and
in the case where said third intermediate value (V₇) is less than unity, executing said clipping step.

5. The method according to claim 1, wherein said step of obtaining a reduction value (J) comprises the steps of:
defining a reduction table (41) that defines a plurality of fields, each field being associated to a respective reduction value (J);
selecting by means of said result (V₆, index_clip) that expresses the relationship existing between said magnitudes in a field of said reduction table (41);
extracting said reduction value (J) associated to said selected field (41).

6. The method according to claim 5, wherein the phase of defining a reduction table (41) is based upon the definition of a succession of reduction values (J) increasing with respect to one another according to a function chosen from among: square root, logarithmic function, sigmoid function, and linear and non-linear approximations thereof.

7. The method according to claim 3, wherein said clipping step comprises the steps of:
multiplying said real vector component (Vq) and said imaginary vector component (Vd) by said reduction value (J) to obtain, respectively, a fourth intermediate value (V₉) and a fifth intermediate value (V₁₀); and
normalizing said fourth intermediate value (V₉) and said fifth intermediate value (V₁₀) with respect to said first parameter (2^{K}).

8. The method according to claim 1, further comprising the steps of:
adding said result (V₆, index_clip) of said comparison step to a second parameter (i_offset_d); and
translating the value of said result (V₆, index_clip) of said comparison step into a range of values compatible with operation of said electric machine.

9. A control device for electric motors configured for implementing the method according to claim 1.

10. A software product that can be loaded into processing means of a control device for electric motors, said software being designed, when run, to cause the processing means to implement the control method according to claim 1.
